(19) United States
(12) Patent Application Publication
(10) Pub. No.: US 2010/0067577 A1
(43) Pub. Date: Mar. 18, 2010

(54) METHOD AND APPARATUS FOR MANIPULATING BIT STREAMS

(75) Inventor: Amit Porat, Tel-Aviv (IL)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 12/312,156

(22) PCT Filed: Oct. 29, 2007
(86) PCT No.: PCT/IB2007/003263

§ 371 Date: Nov. 23, 2009

Related U.S. Application Data
(60) Provisional application No. 60/863,645, filed on Oct. 31, 2006.

(51) Int. Cl. H04N 7/32; H04N 7/26

(52) U.S. Cl. 375/240.13; 375/240.24; 375/E07.243

(57) ABSTRACT

Trans-rating of successive macroblocks in a video stream occurs in accordance with the block type. For example, an (Inter) Intra-coded macroblock will generally get trans-rated using first algorithm partly decodes the macroblock and modifies coded residual coefficients by raising coefficient quantization. Intra-coded macroblocks generally get trans-rated using a second technique that operates first to decode the macroblock and then derive all the main decisions therefrom to re-encode the stream using the original decisions. Separately trans-rating Inter-coded and Intra-coded macroblocks in this manner reduces computational complexity, as compared to the use of a single trans-rating algorithm, while still maintaining good video quality.

### CROSS-REFERENCE TO RELATED APPLICATIONS

This application claims priority under 35 U.S.C. 119(e) to U.S. Provisional Patent Application Ser. No. 60/863,645, filed 31 Oct. 2007, the teachings of which are incorporated herein.

### TECHNICAL FIELD

This invention relates to a technique for manipulating the bit rate of a bit stream, particularly a video bit stream.

### BACKGROUND ART

A trans-rating algorithm, some times referred to as a Rate-Shaping Algorithm, constitutes a real-time algorithm for manipulating the bit rate of a compressed digital video stream to a desired result. Trans-rating (Rate-Shaping) algorithms find use in applications with in the Broadcast Television Industry. For example, when using a statistical video multiplexer to combine a plurality of individual video bit rate streams and output all of them on a constant bandwidth channel, the bit rates of the individual streams undergo trans-rating so that their sum does not exceed the desired constant bandwidth rate. In the case of Internet Protocol Television (IPTV), the operator generally needs to transmit a different Constant Bit Rate (CBR) streams to each customer and typically does so by applying a trans-rating algorithm on the incoming bit streams.

In the case of video encoded using the well-known Motion Picture Experts Group 2 (MPEG 2) standard, there exits three types of trans-rating algorithms, hereinafter referred to as T1, T2 and T3. The first (T1) trans-rating algorithm serves to partly decode an input stream bit stream and modify the coded residual coefficients only by raising their quantization. The second (T2) trans-rating algorithm operates first to decode the input stream, then derive all the main decisions from the input stream, and re-encode the stream using the original decisions. The third (T3) algorithm operates to decode the input stream and fully re-encode the result to the output stream.

These algorithms trade-off computational complexity against video quality to varying degrees. The T1 algorithm offers the lowest computational complexity while the T3 algorithm affords the best result. When operating on a broadcast quality video stream, the T2 algorithm will afford nearly as good video quality as the T3 algorithm. Although the T1 algorithm affords decent video quality for MPEG-2 encoded video bit streams, this algorithm yields unacceptable quality video for input streams encoded using the H.264 coding standard.

There is a need to provide a system and method for trans-rating that will produce relatively high quality video, such as that afforded using the T2 algorithm, while incurring relatively low computational complexity, generally not much more than the T1 algorithm.

### BRIEF SUMMARY OF THE INVENTION

Briefly, in accordance with a preferred embodiment of the present principles, there is provided a method for trans-rating, i.e., manipulating the bit-rate, of successive macroblocks in a bit stream. The method commences by analyzing a successive macroblock as well as previously trans-rated neighboring macroblocks blocks to establish a macroblock type. The successive macroblock then undergoes trans-rating in accordance with the macroblock type. For example, an Intra-coded macroblock will generally get trans-rated using the T2 algorithm, whereas Inter-coded blocks gets trans-rated using the T1 algorithm. Separately trans-rating Inter-coded and Intra-coded macroblocks in this manner reduces computational complexity, as compared to the use of a single trans-rating algorithm, while still maintaining good video quality.

### BRIEF DESCRIPTION OF THE DRAWING

FIG. 1 depicts a block schematic diagram of an apparatus in accordance with a preferred embodiment of the present principles for trans-rating successive macroblocks.

### DETAILED DESCRIPTION

In accordance with the present principles, there is a provided a technique for trans-rating successive macroblocks in a bit stream, and especially, a video bit stream encoded by the H.264 standard. Before proceeding to discuss the trans-rating technique of the present principles, a brief description of the H.264 coding standard will prove useful.

The H.264 coding standard comprises an advanced video compression standard that uses a set of progressive tools to reach the best video quality with lower bit rates. Because of the complexity associated with the H.264 video compression standard (mostly because of spatial dependency between Intra macroblock compression), the T1 trans-rating algorithm often will afford a very poor quality result.

The H.264 compression standard contains certain features that adversely affect output video quality following application of the T1 algorithm. In addition to the macroblock self-reduction in quality due to higher quantization, features in the H.264 compression standard produce a drift in quality. The quality drift produced by the different features of the standard is not equal in extent.

The drift in quality associated with the H.264 compression can give rise to certain difficulties. For example, like in the MPEG 2 standard, the H.264 video compress standard allows for Inter-prediction coding whereby certain macroblock residuals undergo coding in relation to a certain compensated reference. Changing the reference causes a drift in quality that reaches zero on an I-frame. Assuming a quality input bit stream and moderate trans-rating, such a drift will have little effect on the output quality of a video stream.

The H.264 compression standard prescribes the use of de-blocking filter to modify blocks edges of a reference macroblock to decrease the deblocking effect. This filter makes use of a quantization scale parameter on the various macroblocks. The drift caused by such de-blocking is minimal assuming a good quality input bit stream.

The H.264 compression standard provides for Intra-prediction coding of macroblocks whereby neighboring pixels as reference to predict the coding for current pixels. When such pixels have been modified by trans-rating, a drift in quality can occur. Unfortunately, this drift will increase in proportion to the number of Intra Predications that occur. The H.264 video compression standard provides for four different 16×16 Intra-prediction modes and nine separate 4×4 modes. The 4×4 modes perform Intra-predication on each 4×4 Block and increase the quality drift effect.

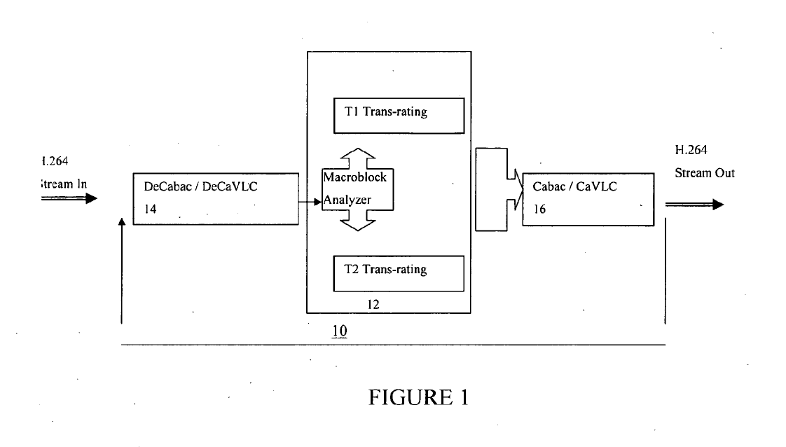

In accordance with the present principles, the past difficulties associated with trans-rating H.264-coded bit streams are avoided by trans-rating using a combination of the T1 and T2 trans-rating algorithms. FIG. 1 depicts a block schematic diagram of an apparatus 10 for performing trans-rating in accordance with the present principles. The apparatus 10 includes a macroblock analyzer 12 which takes the form of a programmed processor or the like, an application specific integrated circuit (ASIC) or a field programmable logic array, or other combination of hardware and software elements having the capability of differentiating between. Intra-coded and Inter-coded macroblocks and for applying one of the T1 and T2 trans-rating algorithms based on the block type (and the macroblocks within effecting range). When trans-rating using the T1 algorithm, the macroblock analyzer 12 will re quantize the coded residual coefficients using a new quantization scale. When trans-rating using the T2 algorithm, the macroblock analyzer 12 makes use of reference information based on decoding and makes all decisions from the input stream for re-encoding the macroblock.

Prior to trans-rating by the macroblock analyzer 12, an encoded video bit stream will first undergo decoding by a decoder 14. In practice, the incoming bit stream received by the decoder 14 is encoded with H.264 standard using either context-based adaptive binary arithmetic coding (CaBC) or context based variable length coding CaVLC. Following trans-rating by macroblock analyzer, an encoder 16 re-encoded the now-trans-rated macroblock using one of CaBC or CaVLC coding based on the decoding performed by the decoder 14.

In operation, the macroblock analyzer 12 of FIG. 1 will generally apply the T2 algorithm on Intra-coded macroblocks as long the analyzer possesses a spatial reference for each block. For Inter-coded macroblocks, the macroblock analyzer 12 will apply the T1 trans-rating algorithm. The T1 Inter-coded trans-rated macroblocks do not require any reference so the macroblock analyzer 12 will not have to build and keep all the relevant reference frames. Under such circumstances, the macroblock analyzer 12 can make use of the T1 algorithm and save on the computational complexity. This approach also enables an implementation of the technique of the present principles by parallel systems (not shown). The quality loss associated with applying the T1 algorithm on Inter-prediction coded macroblocks is not extensive.

Intra-coded macroblocks undergo trans-rating using the T2 algorithm as long as the prediction information remains available. (Such prediction information is not always available in Inter Slices). The Intra-coded macroblock mode is derived from the input macroblock. Using such information, the macroblock analyzer 12 will fully decode the input macroblock as a basis for re encoding the output macroblock. Using the T2 trans-rating algorithm on Intra-coded macroblocks becomes more costly in terms of computational complexity but yields a very good result on anchor slices which will effect the over all quality of the video.

The decision whether to apply either the T1 or T2 trans-rating algorithms on Intra macroblocks depends on the macroblock context. For Intra-Picture Slices, generally referred to as I slices, and for Switching Intra Picture Slices, referred to as SI slices, all of the macroblocks are Intra-coded macroblocks. Hence, reference information for each block remains available as long as the T2 trans-rating algorithm is applied to such blocks. For an Intra-coded macroblock in P, SP, and B Slices, it depends on a “constrained_intra_pred_flag” coded on the Picture Parameter Set (PPS) associated with the macroblock. If this flag is set to unity, the T2 trans-rating algorithm is chosen for all Intra macroblocks in Inter Slices. Otherwise, the T1 trans-rating algorithm is applied or the macroblock is left as is.

In the cases when the T2 algorithm cannot be applied on an Intra macroblock coded using H.264 compression, T1 will be applied on Intra macroblocks within Inter Slices only 16×16 macroblocks in cases they are not used as predictors for following macroblocks.

The above description of the apparatus 10 of FIG. assumes the following:

(i) The H.264 streams input to the apparatus 10 are fully H.264 compatible;

(ii) The H.264 streams are broadcast quality;

(iii) The H.264 streams have been encoded using a legitimate decision making algorithm;

(iv) The macroblock analyzer 12 has the ability to average the performance of the T1 and T2 algorithms; and

(v) The trans-rating will reduce the bit rate to a certain limit depending on the input quality and will not exceed a 40% decrease in bit rate over a number of frames.

The foregoing describes a technique for trans-rating a bit stream that affords relatively low complexity and relatively high quality.

1. A method comprising the steps of:
analyzing a successive macroblock as well as previously trans-rated neighboring macroblocks blocks to establish a macroblock type; and
trans-rating the successive macroblock in accordance with the macroblock type.

2. The method according to claim 1 wherein the analyzing step comprises the step of establishing the macroblock type as one of an intra-coded macroblock and an inter-coded macroblock.

3. The method according to claim 2 wherein an inter-coded macroblock undergoes trans-rating in accordance with a first trans-rating technique.

4. The method according to claim 2 wherein an intra-coded macroblock undergoes trans-rating in accordance with a second trans-rating technique.

5. The method according to claim 3 wherein the first trans-rating technique partly decodes the macroblock and modifies coded residual coefficients by raising coefficient quantization.

6. The method according to claim 4 wherein the second trans-rating technique decodes the macroblock and then derives decisions from the decoded macroblock for subsequent re-encoding.

7. The method according to claim 4 wherein the intra-coded macroblock is trans-rated in accordance with the second technique so long as prediction information remains available.

8. The method according to claim 7 wherein the intra-coded macroblock undergoes trans-rating in accordance with the first technique when no prediction information exists.

9. Apparatus comprising:
a decoder for decoding a stream of macroblocks;
a macroblock analyzer for analyzing a successive macroblock as well as previously trans-rated neighboring macroblocks blocks to establish a macroblock type; and for trans-rating the successive macroblock in accordance with the macroblock type; and
an encoder for encoding the successive macroblock following trans-rating.

10. The apparatus according to claim 1 wherein the macroblock analyzer establishes the macroblock type as one of an intra-coded macroblock and an inter-coded macroblock.

11. The apparatus according to claim 10 wherein the macroblock analyzer trans-rates an inter-coded macroblock in accordance with a first trans-rating technique.

12. The apparatus according to claim 10 wherein the macroblock analyzer trans-rates an intra-coded macroblock in accordance with a second trans-rating technique.

13. The apparatus according to claim 11 wherein the first trans-rating technique partly decodes the macroblock and modifies coded residual coefficients by raising coefficient quantization.

14. The apparatus according to claim 12 wherein the second trans-rating technique decodes the macroblock and then derives decisions from the decoded macroblock for subsequent re-encoding.

15. The apparatus according to claim 12 wherein the macroblock analyzer trans-rates an intra-predictive macroblock in accordance with the second technique as long as prediction information remains available.

16. The apparatus according to claim 15 wherein the macroblock analyzer trans-rates an intra-coded macroblock in accordance with the first technique when no prediction information exists.
